(19) United States
(12) Patent Application Publication
(10) Pub. No.: US 2024/0313956 A1
(43) Pub. Date: Sep. 19, 2024

(54) SECURITY FOR IDENTITY AND ACCESS MANAGEMENT IN IOT SYSTEMS

(71) Applicant: OPEN TEXT HOLDINGS, INC., Menlo Park, CA (US)

(72) Inventors: Edward Wrenbeck, Ira, MI (US); Eileen Gilbert, Bloomfield Township, MI (US); Dileep Kunnath Madathil, Alpharetta, GA (US)

(21) Appl. No.: 18/183,978

(22) Filed: Mar. 15, 2023

(51) Int. Cl. H04L 9/08; H04L 9/14

(52) U.S. Cl. CPC H04L 9/0861; H04L 9/14

(57) ABSTRACT

Systems, methods and products for authentication of IoT devices prior to allowing those devices to access IoT data streams. A device authorized security protocol (DASP) engine generates an encrypted token using information associated with the requesting device and returns the token to this device. The device then transmits the token with its communication to an IoT platform, which extracts the token and provides the token to the DASP engine for authentication of the transmitting device. If the device is authenticated, the communication is processed normally, but if not, the normal processing is interrupted. This device authentication process is performed in addition to existing password or certificate based authentication protocols. The DASP engine also provides an encrypted token to the IoT platform which the platform includes with communications to IoT devices so that the devices can send the token the DASP engine for authentication of the platform.

### TECHNICAL FIELD

The invention relates generally two systems and methods for identity and access management in communications between internet of things (IoT) prices, and more particularly to systems and methods for enabling the authentication of a device that is attempting to access IoT data, apart from verifying a credential such as a password or certificate.

### BACKGROUND

Increasing numbers of devices that are “smart” and can communicate with each other are becoming available to the public. Frequently, these devices or designed to communicate with each other over the internet or other communication networks (e.g., wifi networks, bluetooth links, etc.) The network of these devices is commonly referred to as the internet of things (IoT). The IoT enables devices such as sensors to communicate data that they have obtained to various other connected devices. For example, a person's smartwatch may collect GPS location data, biometric data, etc. Which may then be communicated to the cloud and processed for use by that person, or by other entities that are authorized to use the data.

The various communication links that are used to transmit data from one IoT device to another are commonly shared by various different IoT devices, so it is important to ensure that the communications are secure and that the communicated data is only made available to devices that are authorized to access it. It is therefore necessary to employ security measures to safeguard the communications.

IoT solutions may use various different protocols, but they are generally all message-based protocols. For example, some of the more popular protocols are MQTT and MQT storm. Communications in these protocols follow a publish and subscribe (“pubsub”) model in which the device can publish to a device queue and subscribe to a queue, and act on these events. There are two types of authentication mechanisms that are currently supported for the pubsub model—a password mechanism and a certificate based authentication mechanism. When a device needs to connect to a queue, it simply has to provide a basic credential, which is either a username and password or a certificate. It should be noted that “queue,” as used herein, should be construed to include a device data stream.

The problem is that the username/password or the certificate may be intercepted, and they may then be used by an impostor device to access the queue and obtain the information that was intended to be accessed by the authorized device. As long as a device has the password or certificate, it can access the queue in the same way as the authorized device—there is no authentication of the device itself. Thus, for example, if the code for an IoT garage door opener installed in someone's home is intercepted, this code can be used to access the garage door opener and open or close the garage door, even though the code is not being used by an authorized entity (i.e., the homeowner's garage door controller).

It would therefore be desirable to provide systems and methods which reduce or eliminate some of the problems described above.

### SUMMARY

The present disclosure details systems, methods and products that enable authentication of IoT devices prior to allowing those devices to access IoT data streams. A device that needs to send data or commands to another device communicates with a device authorized security protocol (DASP) engine. The DASP engine generates an encrypted token using information associated with the requesting device and returns the token to this device. The device then transmits the token with its communication to an IoT platform, which extracts the token and provides the token to the DASP engine for authentication of the transmitting device. If the device is authenticated, the communication is processed normally, but if not, the normal processing is interrupted.

This device authentication process is performed in addition to existing password or certificate based authentication protocols.

One embodiment comprises a system for secure IoT communications, the system comprising an IoT platform, one or more IoT devices communicatively coupled to the IoT platform, and a DASP engine communicatively coupled to the IoT devices and the IoT platform. The DASP engine is configured to generate an encrypted device protection code based on information associated with a first IoT device of the one or more IoT devices and to provide the encrypted device protection code to the first IoT device. The first IoT device is configured to generate a communication that contains the encrypted device protection code and transmit the communication to the IoT platform. The IoT platform is configured to extract the encrypted device protection code from the communication in response to receiving the communication and provide the encrypted device protection code to the DASP engine for authentication of the first IoT device. In response to the DASP engine authenticating the first IoT device, the IoT device is configured to process the communication. In response to the DASP engine not authenticating the first IoT device, the IoT device is configured to prevent processing of the communication.

The DASP engine may be either internal to the IoT platform or external to the IoT platform. The system may include a data store coupled to the DASP engine, where the DASP engine is configured to store a plurality of key-value pairs in the data store, each key-value pair including a hash of a device identifier and a hash of a device protection code. In some embodiments, the DASP engine is configured to authenticate a received device identifier hash and a received device protection code hash by matching them to a corresponding key-value pair in the data store.

The DASP engine may be configured to generate the encrypted device protection code by generating a nonce and generating the device protection code using the nonce. The DASP engine may be configured to periodically generate a new device protection code for the first IoT device, such as by generating new device protection codes for the IoT device at predetermined intervals.

The IoT platform may be configured to verify a password provided by the IoT device with the communication in response to receiving the communication and prior to extracting the encrypted device protection code from the communication.

In some embodiments, the system may include a second IoT device, wherein the DASP engine is configured to generate a second encrypted device protection code based on information associated with the IoT platform and provide the second encrypted device protection code to the IoT platform. The IoT platform may be configured to generate a second communication (following the first communication from the first IoT device) that contains the second encrypted device protection code and transmit the second communication to the second IoT device, where the second IoT device is configured to extract the second encrypted device protection code from the communication and provide the second encrypted device protection code to the DASP engine for authentication of the IoT platform in response to receiving the second communication. In response to the DASP engine authenticating the IoT platform, the second IoT device may process the second communication, and in response to the DASP engine not authenticating the IoT platform, the second IoT device may prevent processing of the second communication.

An alternative embodiment may comprise a method for secure IoT communications. In this method, device information for a first IoT device is provided to a DASP engine. The DASP engine generates a device protection code based on the provided device information and encrypts the device protection code. The DASP engine may store the device protection code in a data store as part of a key-value pair containing a device identifier for the first IoT device. The DASP engine then provides the encrypted device protection code to the first IoT device. The first IoT device generates a communication containing the encrypted device protection code in the body of the communication and transmits the communication to a recipient device such as an IoT platform. The recipient device extracts the encrypted device protection code from the communication and provides the encrypted device protection code to the DASP engine with an identifier of the first IoT device. The DASP engine then authenticates the first IoT device using the encrypted device protection code and provides an authentication result to the recipient device. The recipient device then processes the communication if the authentication result authenticates the first IoT device or prevents processing of the communication if the authentication result does not authenticate the first IoT device.

The method may also include the recipient device authenticating the first IoT device using a first, long-term authenticator, where the authentication is performed by the recipient device independently of the DASP engine authenticating the first IoT device using the device protection code. The first, long-term authenticator may comprise, for example, a password provided by the first IoT device to the recipient device. The encrypted device protection code may be a short-term authenticator which is configured to expired in a predetermined period of time.

The DASP engine may periodically generate a new device protection code for the first IoT device (e.g., at predetermined intervals). The DASP engine may authenticate the first IoT device by matching the received device protection code and a device identifier to a corresponding key-value pair in the data store.

Another alternative embodiment may comprise a computer program product comprising a non-transitory computer-readable medium which stores instructions that are executable by a processor to perform a method as described above. Numerous alternative embodiments may also be possible.

The disclosed embodiments may provide a number of advantages over existing systems and methods. For example, the DASP engine provides an additional security layer which assists in protecting data, applications & device data streams. The DASP engine also provides attestation for a device stream, which increases trust in the data stream. The DASP engine can be implemented in a variety of ways, including embodiments which allow an interested party to store the key-value pair in a separate location from the IoT platform, thus abstracting the operation of the IoT platform from the protection of the key-value pair and further distributing risk across the IoT system.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a block diagram illustrating a publish-subscribe model for IoT communications in accordance with the prior art.

FIG. 2 is a block diagram illustrating the security implemented in an existing IoT model.

FIG. 3 is a block diagram illustrating an example of a system that implements device authentication using a DASP engine in accordance with some embodiments.

FIG. 4 is a transaction diagram illustrating the communications between the different components of the system of FIG. 3 for provisioning of the IoT device in the network in accordance with some embodiments.

FIG. 5 is a flow diagram illustrating an example of a method for provisioning the IoT device in accordance with some embodiments.

FIG. 6 is a transaction diagram illustrating the use of a device protection code to protect communications from the IoT device to the IoT platform in accordance with some embodiments.

FIG. 7 is a flow diagram illustrating an example of a method for communicating from the IoT device to the IoT platform in accordance with some embodiments.

FIG. 8 is a transaction diagram illustrating the communications between the different components of the system relating to the communication of a command to the IoT device in accordance with some embodiments.

FIG. 9 is a flow diagram illustrating an example of a method for communicating a command to an IoT device in accordance with some embodiments.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments disclosed herein implement a device authorized security protocol. Because existing security mechanisms for message based IoT cloud applications have shortcomings in their inability to prevent imposter devices from using legitimate passwords and certificates to imitate requests, commands, etc. From authentic devices.

The present embodiments provide some additional security beyond existing passwords or certificates to secure devices and the cloud IoT platform. This allows the IoT platform to ensure that an actual device that is sending data to the platform or issues a command to a device is authenticated, and allows devices to ensure that received commands originated from the correct IoT platform.

As more and more devices become available and these devices are increasingly capable of interacting with each other via the IoT, security becomes increasingly important. In order to better understand the problems that are present in existing systems, it may be helpful to show how existing systems function.

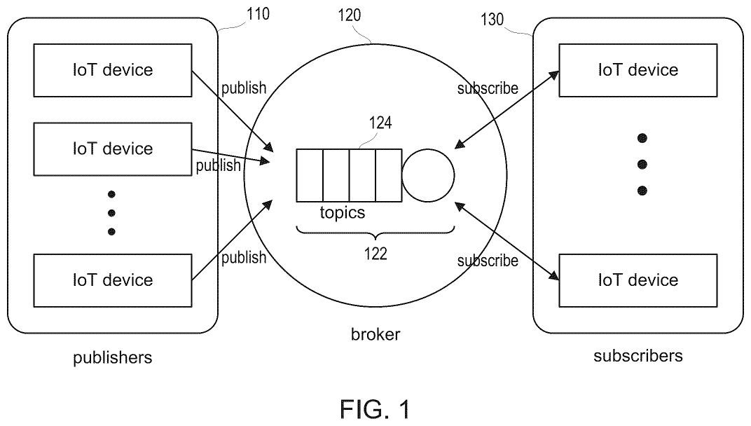

Referring to FIG. 1, a diagram illustrating a publish-subscribe (“pubsub”) model for IoT communications is shown. In this figure, a first set of devices 110 publishes information to an information broker 120. The devices in set 110 may include various different devices or groups of devices that may have sensors, processing capabilities, software, etc. These devices are individually addressable and can connect with other devices and systems over communications networks (e.g., the internet, lans, bluetooth links, and the like) to exchange data.

Various different types of information, such as sensed data and commands may be published by devices 110. Information broker 120 maintains one or more queues 122, and when the broker receives information published by devices 110, the information is stored in the queues. Queues 122 maintain a set of topics (e.g., 124) and the queues store information into the different topics.

The information stored in queues 122 is consumed by a second set of devices 130. The devices in set 130 subscribe to queues 122 (and more particularly to topics 124) to access the data published by the devices in set 110. The devices in set 110 and set 130 are not necessarily mutually exclusive—some devices may both publish and subscribe to the various queues 122.

As noted above, the publish-subscribe model can use password mechanisms or certificate based mechanisms to authenticate communications with the broker. When a device publishes information to a queue, it simply has to provide the appropriate credential (a username and password or a certificate) to the broker to verify that the device is authorized to publish to the corresponding queue. Similarly, in order for a device to be able to consume information from one of the queues, the device simply provides a valid username and password or a certificate to the broker.

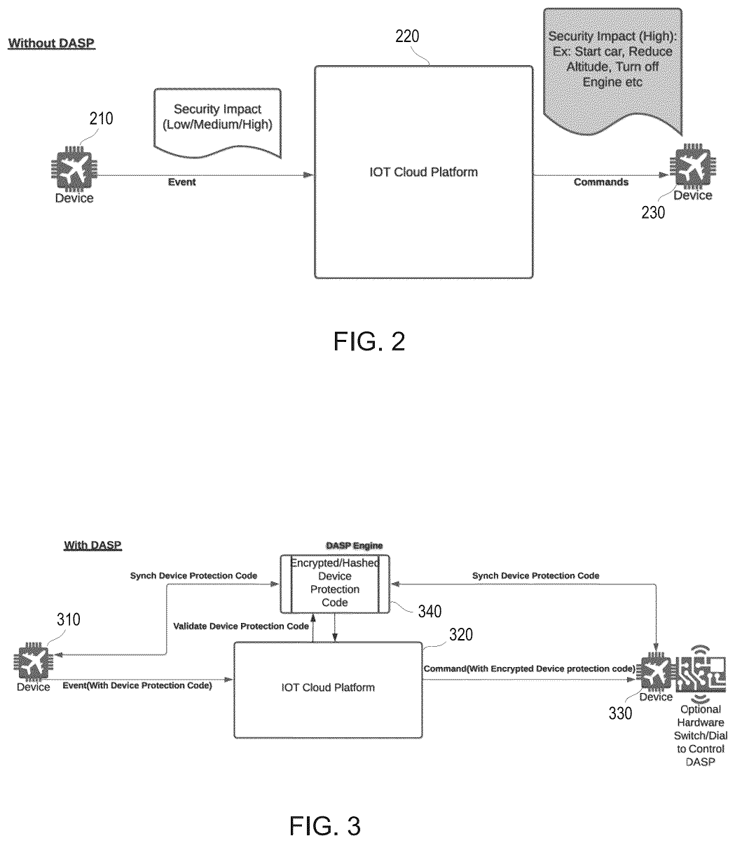

Referring to FIG. 2, a diagram is shown to illustrate the security implemented in an existing IoT model. As depicted in this figure, a first device 210 publishes event information to an IoT cloud platform 220. Device 230 is also coupled to IoT cloud platform 220, but rather than publishing information to the IoT platform, device 230 subscribes to a queue maintained by the platform and, as depicted in the figure, receives a command from the IoT platform.

The communications between IoT cloud platform 220 and devices 210 and 230 are secured using a credential. The event information published to the IoT cloud platform from device 210 includes a credential, which may be a username and password or a certificate showing that the device is authorized to publish information to the corresponding queue on the IoT platform. IoT cloud platform 220 extracts the credential from the communication that is received from device 210 and verifies the credential (e.g., compares the credential to a list of valid credentials) to ensure that the device is authorized to publish information to the queue. If the credential is valid (e.g., the received username and password matches a username and corresponding password on the list of valid credentials) the IoT platform stores the published information in the corresponding topic in a queue maintained by the platform. If it is determined that the credential is not valid, the it platform may take various actions, such as ignoring the published data (and not storing the data in the queue), generating an alert or notification, storing forensic information, or the like.

Similarly, when device 230 attempts to access the information in the queue which was published by device 210, it is necessary for device 230 to provide a credential (in this case a username and password) to the IoT cloud platform. When IoT cloud platform 220 receives the credential, it verifies the credential in the same manner in which it verified the credential of device 210 (i.e., it matches a corresponding username and password on a list of valid credentials). If the credential is verified, the requesting device is presumed to be authorized to receive the information, and the requested information is returned to the device. If the IoT platform determines that the credential is not valid, it may ignore the request, store forensic information, ignore the request, etc.

While the credential based security implemented in this example is useful, the system still has a number of security vulnerabilities. For example, the credentials that are used to secure the communications between the devices and the IoT platform may be intercepted or stolen, and may be used by devices that are not actually authorized to access the queues and corresponding information. For instance, if stolen credentials are used by an unauthorized device to publish information to the IoT platform, the communication from the unauthorized device will appear to the IoT platform to be a publication of genuine publication from an authorized device, so the bogus information will be stored in the queue. If the stolen credentials are used by an unauthorized device to retrieve information from a queue on the IoT platform, the IoT platform will, upon determining that the credential received with the request is genuine, the unauthorized device will appear to be an authorized subscriber, so it will be allowed to obtain the requested information. No multifactor authentication is available in this system. The system is therefore vulnerable to fake requests, replay/relay attacks, and the like.

As a real-world example, consider the case in which a wrongdoer has sniffed the code to a person's garage door opener. After the wrongdoer has obtained the code, the wrongdoer can open the person's garage door because the code is the only indication of their authorization that is necessary. The wrongdoer has the garage door code and there is no mechanism in place to verify that the person using the code (e.g., the wrongdoer) is an entity authorized to open the garage door.

Embodiments disclosed herein address these security vulnerabilities using a solution in which there is some kind of a unique, known item—a token—that enables authentication of the device that is communicating with the IoT platform. The system provides an additional engine which will communicate with the device gateway using secured https or ssl protocols, which means the system can verify the ip of the both the posting and retrieving devices. The engine is a DASP engine that is used to generate encrypted tokens which are associated with the specific devices at the known ip addresses.

The tokens are generated from nonces—arbitrary numbers that are each used just once. The tokens are relatively short lived and can expire. It is possible to schedule a time to extend the lives of the tokens. The tokens/nonces are persisted in the DASP engine, in a cache, or in some other memory or data storage. There is only one source for the tokens/nonces—the DASP engine. The tokens are pushed to the devices from this single source. The DASP engine may be configured to periodically generate new tokens/nonces. For example, it may be desirable to limit the life of the tokens/nonces to five minutes, so every five minutes, the DASP engine will generate new tokens/nonces and push a new token/nonce to each unique device. The frequent changing of the tokens/nonces.

After a device has received a token/nonce from the DASP engine, the device stores the token/nonce so that it can be included in every communication the device sends to the IoT platform. The token/nonce must be included in the payload of the communication to the IoT platform so that the IoT platform can extract the token/nonce and use it to verify that the device from which the communication was received is the correct authorized device.

When the IoT platform receives a communication from a device, it extracts the token/nonce from the payload of the communication. The IoT platform then accesses the DASP engine with a request to validate the token/nonce extracted from the payload of the communication. If the DASP engine validates the token/nonce, the device that sent the communication to the IoT platform is a correct authorized device, and the IoT platform would proceed with the normal execution flow. If, on the other hand, the DASP engine cannot verify the token/nonce, the device that sent the communication to the IoT platform is determined not to be a correct, authorized device, so the communication from this device is simply ignored. As an alternative to ignoring the communication, the IoT platform may provide some type of alert or take a corrective action in response to the failed authentication of the device.

Referring to FIG. 3, a diagram is shown to illustrate an example of a system that implements device authentication using a DASP engine. As depicted in this figure, a device (310) is again coupled to an IoT platform (320) and is configured to publish events to the IoT platform. A second device (330) is also coupled to IoT cloud platform (320) and is subscribed to a topic in a queue of IoT platform (320) so that it can receive a command from the platform.

When devices (310) and (330) are provisioned by IoT platform (320), the platform also communicates with DASP engine (340) so that the DASP engine will be aware of these devices. Since the devices will need to include tokens/nonces in their communications with the IoT platform in order to enable verification of the devices, DASP engine (340) proceeds to generate these tokens/nonces for the devices. The generated tokens/nonces are stored by the DASP engine and the respective tokens/nonces are forwarded from the DASP engine to each of the devices (i.e., the token/nonce for device (310) is sent to device (310), and the token/nonce for device (330) is sent to device (330)). Upon receiving the respective tokens/nonces, each of the devices stores the corresponding token/nonce in its own data store (e.g., a memory or other data storage device). When DASP engine (340) periodically re-generates new tokens/nonces for the devices, the new tokens/nonces will be sent to the respective devices and stored in those devices for use in future communications by the devices.

After devices (310) and (330) have received the encrypted tokens/nonces from DASP engine (340), they can use these in communications with IoT platform (320). In the example of FIG. 3, device (310) needs to publish an event to IoT platform (320), and device (330) will receive a resulting command from the platform. Device (310) therefore generates a communication containing the event and includes the token/nonce received from DASP engine in the payload of the communication. The communication is then published from device (310) to IoT platform (320). When IoT platform receives the communication, it extracts the token/nonce from the communication and sends the token/nonce to DASP engine (340) for verification/validation of the token/nonce. DASP engine (340) then returns to IoT platform (320) an indication of whether the token/nonce is valid (i.e., the token/nonce is correct and is associated with device (310)). If the DASP engine indicates that the token/nonce is not valid, the IoT platform ignores the communication. If the DASP engine indicates that the token/nonce is valid, the IoT platform will put the event in the appropriate queue according to the normal execution flow of the platform.

If the token/nonce of the event publication from device (310) is valid and IoT platform (320) has stored the even in a queue, the IoT platform then needs to send a corresponding command to device (330), which in this example is assumed to have subscribed to the queue in which the event has been stored. Just as DASP engine (340) generated a token/nonce for each of the devices, it also creates one for IoT platform (320). The IoT platform, which has stored the token/nonce it received from the DASP engine, includes this token/nonce in the payload of a communication conveying the command to device (330). When device (330) receives the communication, it extracts the token/nonce from the communication and sends the token/nonce to DASP engine (340) for verification of the token/nonce. DASP engine (340) returns to device (330) an indication of whether the token/nonce is valid (i.e., the token/nonce is correct and is associated with IoT platform (320)). If the DASP engine indicates that the token/nonce is not valid, device (330) ignores the communication. If the DASP engine indicates that the token/nonce is valid, device (330) extracts the command from the payload and processes the command according to the normal execution flow of the device.

As noted above, this system adds a level of security at the device level which goes beyond the existing static (username/password and certificate) security measures that may be implemented at the network, transport and application levels. This system is hardware controlled and provides dynamic protection through the use of frequently re-generated tokens/nonces which are provided to the connected devices and the IoT platform. The extra level of protection provided by the present embodiments reduces or eliminates security risks such as compromised certificates, compromised credentials, cloned/fake requests, etc. That are concerns when there is no multi-factor authentication of communications.

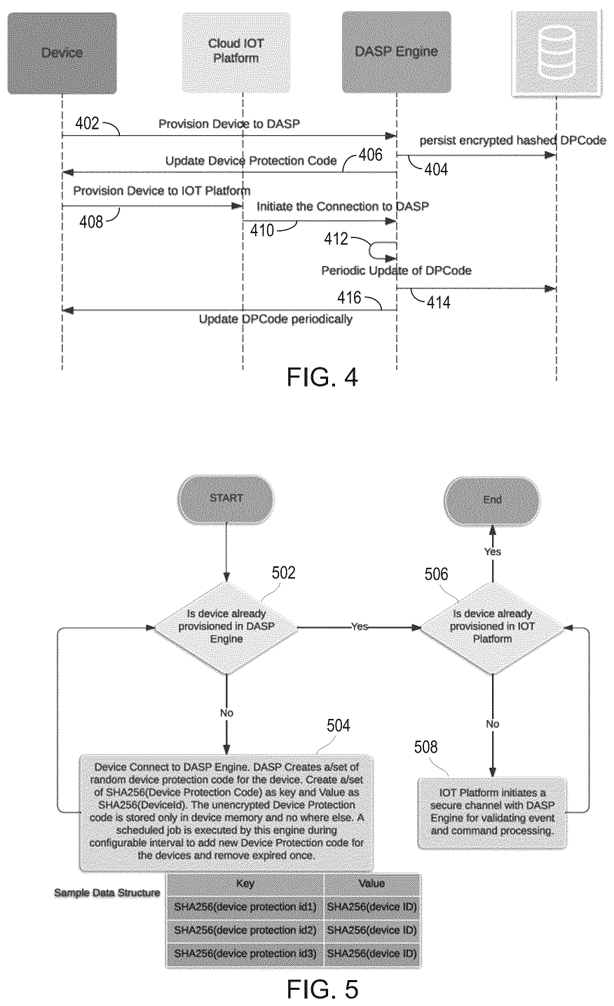

Referring to FIG. 4, a transaction diagram is shown to illustrate the communications in one embodiment between the different components of the system of FIG. 3 relating to the provisioning of the IoT device in the network.

As depicted in FIG. 4, the it device initially communicates request to the DASP engine to provision the device (402). Responsive to the request, the DASP engine generates an encrypted hashed device protection code and stores it in a memory or other storage device (404). After the encrypted hashed device protection code has been stored, the DASP engine responds to the device, returning copy of the device protection code to the IoT device (406). The IoT device then sends a request to the IoT platform to provision the device in the IoT platform (408). The IoT platform then initiates a connection to the DASP engine (410) so that communications from the IoT device can be verified as coming from the correct device. After the IoT platform has initiated the connection to the DASP engine, the DASP engine begins to periodically update the device protection code (412). When the device protection code is updated, the update is persisted in the memory (414) so that it can be used to verify communications from the device. After the updated device protection code has been stored in the memory, it is provided from the DASP engine to the IoT device (416).

Referring to FIG. 5, a flow diagram is shown to illustrate an example of a method for provisioning the IoT device if necessary. The method may begin with a request to provision the device to the DASP engine (not shown in the figure). At step (502), the DASP engine determines whether the IoT device has already been provisioned. If the device has already been provisioned in the DASP engine, the method proceeds to step (506), where it is determined whether or not the IoT device is already provisioned in the IoT platform. If the IoT device has already been provisioned in the IoT platform, the process ends.

Returning to step (502), if it is determined that the IoT device has not yet been provisioned in the DASP engine, the method proceeds to step (504), where the device is provisioned in the DASP engine. Provisioning the device includes having the device connect to the DASP engine, in response to which the DASP engine creates a random device protection code for the IoT device. The DASP engine may alternatively generate a set of random device protection codes for the device. The DASP engine stores a hash of the device protection code as the key of a key value pair, where the value is a hash of the device identifier (id) for the IoT device. The unencrypted device protection code is only stored in the memory of the IoT device—nowhere else. When the IoT device has been provisioned in the DASP engine, a recurring job is scheduled to be executed at predetermined intervals by the DASP engine to generate a new device protection code for the device. When the new device protection code is generated, the old device protection code for the IoT device is removed.

It should be noted that, although the specific embodiment described above stores the hashes of the device protection code and device id as the key-value pair, alternative embodiments could store the device id and device protection code themselves, or other derivatives of the device id and device protection code. References to the hashed device id and hashed device protection code in the data store should therefore be construed to include these other alternatives.

After the IoT device has been provisioned at step (504), the process returns to step (502). Since the device is now provisioned in the DASP engine, the method then proceeds to step (506). If it is determined at step (506) that the IoT device has not yet been provisioned in the IoT platform, the method proceeds to step (508) for the provisioning of the IoT device in the IoT platform. At step (508), the IoT platform initiate a secure channel with the DASP engine. This channel will be used by the IoT platform for validating the device protection code received from the IoT device in communications from the device for the processing of events and commands.

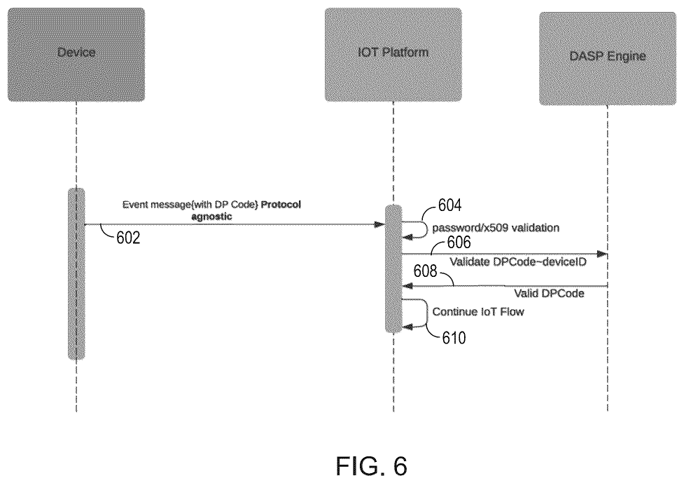

Referring to FIG. 6, a transaction diagram is shown to illustrate the use of a device protection code to protect communications from the IoT device to the IoT platform in one embodiment. When the IoT device needs to communicate an event to the IoT platform, it generates a message that contains the device protection code as well as the event information and transmits the message and a password to the IoT platform (602). When the IoT platform receives the event message from the IoT device, the IoT platform first validates the password (604). If the password is valid, the IoT platform extracts the device protection code from the message and sends the device protection code and the device id to the DASP engine for validation of the device protection code (606). The DASP engine then returns a message to the IoT platform indicating whether or not the device protection code was valid (608). The IoT platform the continues with the appropriate execution flow (610), which may consist of from the normal processing of the event message if the device protection code is valid, or terminating processing of the message if the device protection code is not valid.

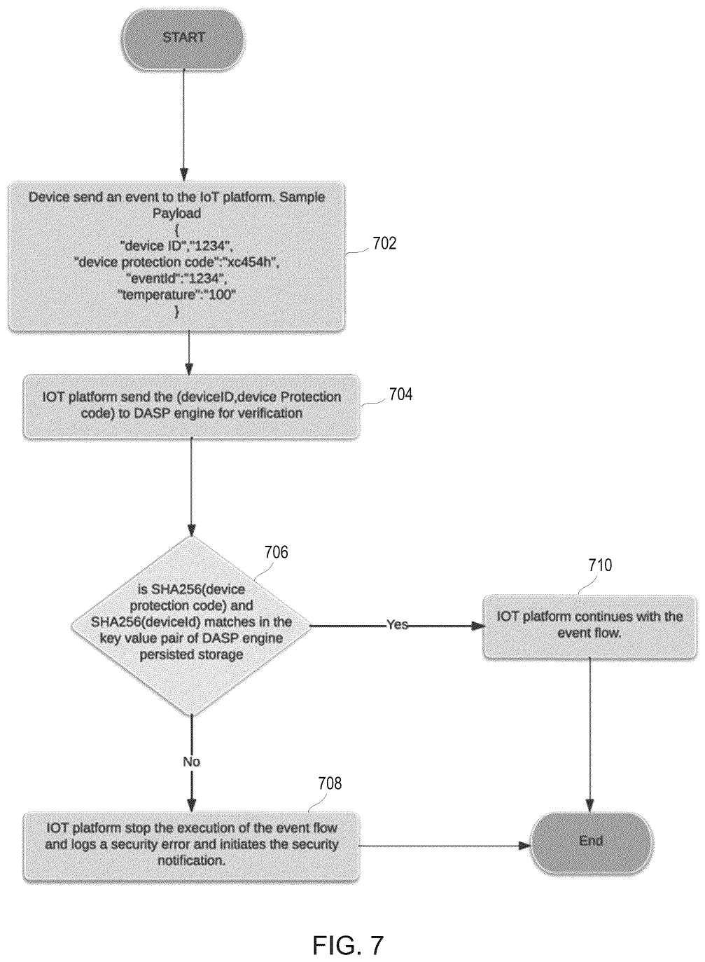

Referring to FIG. 7, a flow diagram is shown to illustrate an example of a method for communicating from the IoT device to the IoT platform. At step (702), the IoT device sends a message to the IoT platform, where the message contains as part of the payload, the device id for the IoT device, the device protection code that the IoT device previously received from the DASP engine, the event id for the event being communicated, and the event data, which in this case is a temperature value. The IoT platform then sends the device id and the device protection code to the DASP engine for verification (704). The DASP engine then compares the received device id and device protection code to the key-value pairs that are stored in the data storage of the DASP engine to determine if the received device id and device protection code match any of the stored key-value pairs (706). If the DASP engine does not find a match for the received device id and device protection code, the DASP engine notifies the IoT platform and the IoT platform stops execution of the event flow, logs a security error and initiates a security notification regarding the message (708). If, on the other hand, the DASP engine does find a match for the received device id and device protection code, the DASP engine notifies the IoT platform, and IoT platform continues execution of the event flow (710).

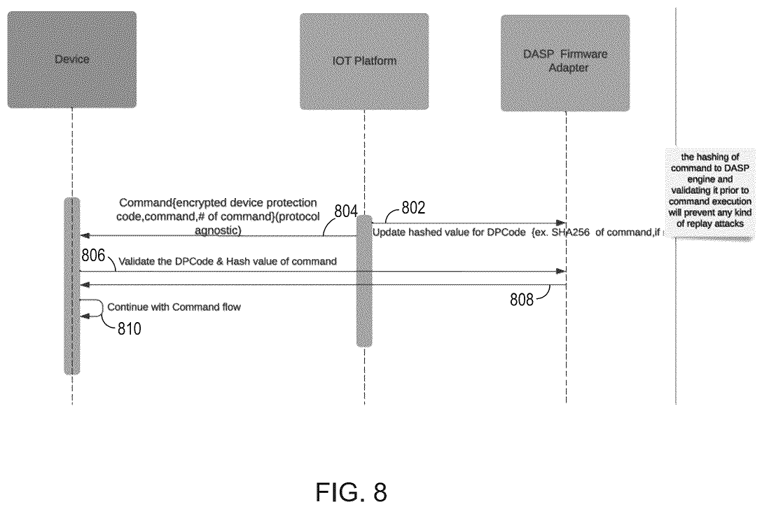

Referring to FIG. 8, a transaction diagram is shown to illustrate the communications in one embodiment between the different components of the system of FIG. 3 relating to the communication of a command to the IoT device. At step (802), the DASP engine retrieves on of the device protection codes for the IoT device and sends the device protection code, device id and command to the IoT platform. The IoT platform then generates a message to the IoT device, where the payload of the message contains the device id, device protection code, command id and command (804). The IoT device then extracts the device protection code and the command from the message and sends the device protection code and the hash value of the command to the DASP engine for validation (806). The DASP engine attempts to validate the device protection code and sends the result to the IoT device (808). If the device protection code is correct, the IoT device continues with the command flow and otherwise terminates execution of the command flow (810).

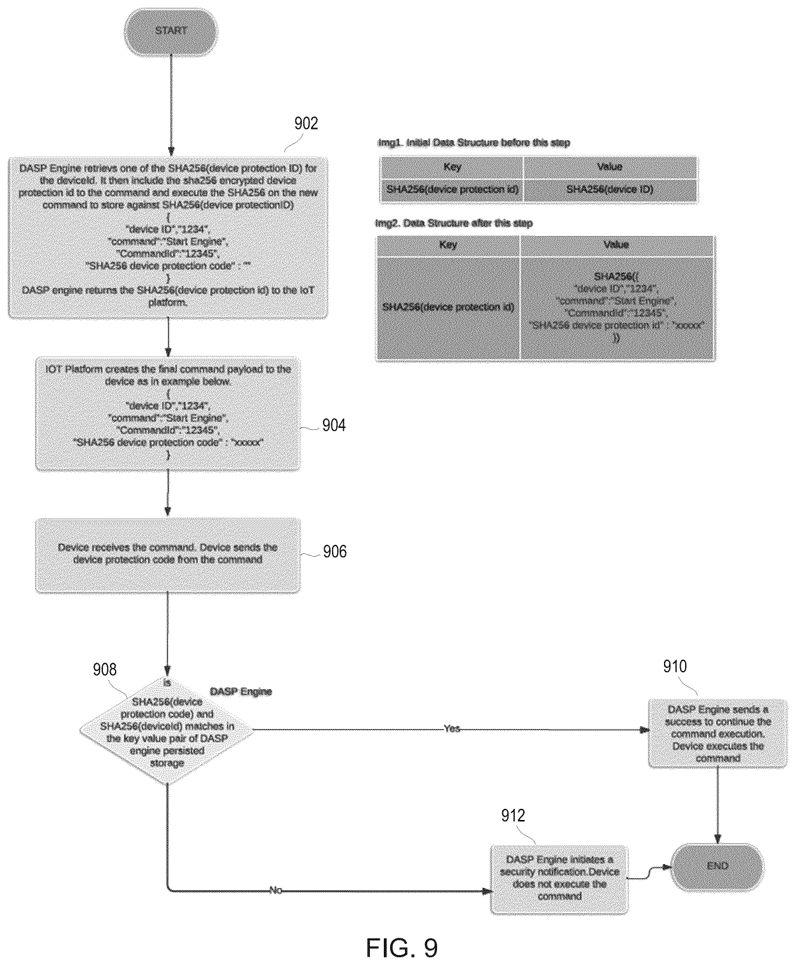

Referring to FIG. 9, a flow diagram is shown to illustrate an example of a method for communicating a command to an IoT device in accordance with one embodiment.

The DASP engine first obtains information for the command message, retrieving a device protection code for the IoT device and sending the hash of the device protection code with the device id for the IoT device, the command and the command id to the IoT platform (902). The IoT platform uses this information to generate a message to transmit the command to the IoT device (904). The payload of the message includes the device id, the hash of the device protection code, the command id and the command. The IoT device then extracts the hash of the device protection code and the command from the message and sends these to the DASP engine for validation (906). The DASP engine attempts to validate the device protection code by matching a hash of the device id and the hash of the device protection code to a corresponding key-value pair stored by the DASP engine (908). If the DASP engine does not find a match, it sends a security notification to the IoT device, which stops the execution of the command flow (910). If the DASP engine finds a match, it sends a success message to the IoT device, which then continues execution of the command flow (912).

Embodiments of the technology may be implemented on a computing system. Any suitable combination of mobile desktop, server machine, embedded or other types of hardware may be used. One exemplary embodiment may be implemented in a distributed network computing environment. The computing environment in this embodiment may include a client computer system and a server computer system connected to a network (e.g., a local area network (LAN), a wide area network (WAN) such as the Internet, mobile network, or other type of network or combination thereof). The network may represent a combination of wired and wireless networks that network computing environment may utilize for various types of network communications.

The computer systems may include, for example, a computer processor and associated memory. The computer processor may be an integrated circuit for processing instructions, such as, but not limited to a CPU. For example, the processor may comprise one or more cores or micro-cores of a processor. The memory may include volatile memory, non-volatile memory, semi-volatile memory or a combination thereof. The memory, for example, may include RAM, ROM, flash memory, a hard disk drive, a solid-state drive, an optical storage medium (e.g., CD-ROM), or other computer readable memory or combination thereof. The memory may implement a storage hierarchy that includes cache memory, primary memory or secondary memory. In some embodiments, the memory may include storage space on a data storage array. The client computer system may also include input/output (“I/O”) devices, such as a keyboard, monitor, printer, electronic pointing device (e.g., mouse, trackball, stylus, etc.), or the like. The client computer system may also include a communication interface, such as a network interface card, to interface with the network.

The memory may store instructions executable by the processor. For example, the memory may include an operating system, a page editing or processing program (e.g., a web browser or other program capable of rendering pages), a server program configured to extend the functionality of the page processing program or other server code. Further, the memory may be configured with a page processable (e.g., capable of being rendered by) by the page editing program. The page may be the local representation of a page, such as a web page, retrieved from the network environment. As will be appreciated, while rendering the page, the page editing/processing program may request related resources, such as style sheets, image files, video files, audio files and other related resources as the page is being rendered and thus, code and other resources of the page may be added to the page as it is being rendered. Application server code can be executable to receive requests from client computers, generate server page files from a set of page assets (e.g., complete web pages, page fragments, scripts or other assets) and return page files in response. A page file may reference additional resources, such as style sheets, images, videos, audio, scripts or other resources at a server computer system or at other network locations, such as at additional server systems.

According to some embodiments, a network environment may be configured with a page such as a web page which is configured to launch and connect to an instance of the server program. The page may include a page file containing page code (HTML or other markup language, scripts or code), stored or generated by the server computer system, that references resources at the server computer system or other network locations, such as additional server computer systems. The page file or related resources may include scripts or other code executable to launch and connect to an instance of the server program.

Those skilled in the relevant art will appreciate that the embodiments can be implemented or practiced in a variety of computer system configurations including, without limitation, multi-processor systems, network devices, mini-computers, mainframe computers, data processors, and the like. Embodiments can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, stored as firmware in chips, as well as distributed electronically over the Internet or over other networks (including wireless networks). Example chips may include Electrically Erasable Programmable Read-Only Memory (EEPROM) chips.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. Steps, operations, methods, routines or portions thereof described herein be implemented using a variety of hardware, such as CPUs, application specific integrated circuits, programmable logic devices, field programmable gate arrays, optical, chemical, biological, quantum or nanoengineered systems, or other mechanisms.

Software instructions in the form of computer-readable program code may be stored, in whole or in part, temporarily or permanently, on a non-transitory computer readable medium. The computer-readable program code can be operated on by a processor to perform steps, operations, methods, routines or portions thereof described herein. A “computer-readable medium” is a medium capable of storing data in a format readable by a computer and can include any type of data storage medium that can be read by a processor. Examples of non-transitory computer-readable media can include, but are not limited to, volatile and non-volatile computer memories, such as RAM, ROM, hard drives, solid state drives, data cartridges, magnetic tapes, floppy diskettes, flash memory drives, optical data storage devices, compact-disc read-only memories. In some embodiments, computer-readable instructions or data may reside in a data array, such as a direct attach array or other array. The computer-readable instructions may be executable by a processor to implement embodiments of the technology or portions thereof.

A “processor” includes any, hardware system, hardware mechanism or hardware component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any suitable programming language can be used to implement the routines, methods or programs of embodiments of the invention described herein, including R, Python, C, C++, Java, JavaScript, HTML, or any other programming or scripting code, etc. Communications between computers implementing embodiments can be accomplished using any electronic, optical, radio frequency signals, or other suitable methods and tools of communication in compliance with known network protocols.

Any particular routine can execute on a single computer processing device or multiple computer processing devices, a single computer processor or multiple computer processors. Data may be stored in a single storage medium or distributed through multiple storage mediums.

Although the steps, operations, or computations may be presented in a specific order, this order may be changed in different embodiments. In some embodiments, some steps may be omitted. Further, in some embodiments, additional or alternative steps may be performed. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Thus, while the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A system for secure Internet-of-Things (IoT) communications comprising:
an IoT platform;
one or more IoT devices communicatively coupled to the IoT platform;
a Device Authorized Security Protocol (DASP) engine communicatively coupled to the one or more IoT devices and the IoT platform;
wherein the DASP engine is configured to
generate an encrypted device protection code based on information associated with a first IoT device of the one or more IoT devices, and
provide the encrypted device protection code to the first IoT device;
wherein the first IoT device is configured to generate a communication that contains the encrypted device protection code and transmit the communication to the IoT platform; and
wherein the IoT platform is configured to
in response to receiving the communication, extract the encrypted device protection code from the communication and provide the encrypted device protection code to the DASP engine for authentication of the first IoT device,
in response to the DASP engine authenticating the first IoT device, process the communication, and
in response to the DASP engine not authenticating the first IoT device, prevent processing of the communication.

2. The system of claim 1, further comprising a data store coupled to the DASP engine, wherein the DASP engine is configured to store a plurality of key-value pairs in the data store, each key-value pair including a hash of a device identifier and a hash of a device protection code.

3. The system of claim 2, wherein the DASP engine is configured to authenticate a received device identifier hash and a received device protection code hash by matching the received device identifier hash and the received device protection code hash to a corresponding key-value pair in the data store.

4. The system of claim 1, wherein generating the encrypted device protection code comprises generating a nonce and generating the device protection code using the nonce.

5. The system of claim 1, Wherein the DASP engine is configured to periodically generate a new device protection code for the first IoT device.

6. The system of claim 5, wherein the DASP engine is configured to generate new device protection codes for the first IoT device at predetermined intervals.

7. The system of claim 1, wherein the IoT platform is configured to, in response to receiving the communication and prior to extracting the encrypted device protection code from the communication, verify a password provided by the IoT device with the communication.

8. The system of claim 1, wherein the DASP engine is internal to the IoT platform.

9. The system of claim 1, wherein the DASP engine is external to the IoT platform.

10. The system of claim 1:
further comprising a second IoT device of the one or more IoT devices;
wherein the DASP engine is configured to
generate a second encrypted device protection code based on information associated with the IoT platform, and
provide the second encrypted device protection code to the IoT platform;
wherein the IoT platform is configured to generate a second communication that contains the second encrypted device protection code and transmit the second communication to the second IoT device; and
wherein the second IoT device is configured to
in response to receiving the second communication, extract the second encrypted device protection code from the communication and provide the second encrypted device protection code to the DASP engine for authentication of the IoT platform,
in response to the DASP engine authenticating the IoT platform, process the second communication, and
in response to the DASP engine not authenticating the IoT platform, prevent processing of the second communication.

11. A method for secure Internet-of-Things (IoT) communications comprising:
providing device information for a first IoT device to a Device Authorized Security Protocol (DASP) engine;
generating, at the DASP engine, a device protection code based on the provided device information;
encrypting, by the DASP engine, the device protection code;
providing, by the DASP engine, the encrypted device protection code to the first IoT device;
generating, by the first IoT device, a communication containing the encrypted device protection code in a body of the communication;
transmitting the communication to a recipient device;
extracting, by the recipient device, the encrypted device protection code from the communication;
providing, by the recipient device, the encrypted device protection code to the DASP engine with an identifier of the first IoT device;
authenticating, by the DASP engine, the first IoT device using the encrypted device protection code;
providing, by the DASP engine, an authentication result to the recipient device; and
processing, by the recipient device, the communication if the authentication result authenticates the first IoT device and preventing processing of the communication if the authentication result does not authenticate the first IoT device.

12. The method of claim 11, further comprising authenticating, by the recipient device, the first IoT device using a first, long-term authenticator, wherein the authenticating is performed by the recipient device independently of the DASP engine authenticating the first IoT device using the device protection code.

13. The method of claim 12, wherein the first, long-term authenticator comprises a password provided by the first IoT device to the recipient device.

14. The method of claim 12, wherein the encrypted device protection code comprises a short-term authenticator which is configured to expired in a predetermined period of time.

15. The method of claim 11, wherein the recipient device comprises an IoT platform.

16. The method of claim 11, further comprising the DASP engine storing the device protection code in a data store as part of a key-value pair containing a device identifier for the first IoT device.

17. The method of claim 11, further comprising the DASP engine periodically generating a new device protection code for the first IoT device.

18. The method of claim 17, wherein the DASP engine generates new device protection codes for the first IoT device at predetermined intervals.

19. The method of claim 11, wherein the DASP engine authenticating the first IoT device using the encrypted device protection code comprises matching the received device protection code and a device identifier to a corresponding key-value pair in the data store.

20. A computer program product comprising a non-transitory computer-readable medium storing instructions executable by one or more processors to perform:
providing device information for a first IoT device to a Device Authorized Security Protocol (DASP) engine;
generating, at the DASP engine, a device protection code based on the provided device information;
encrypting, by the DASP engine, the device protection code;
providing, by the DASP engine, the encrypted device protection code to the first IoT device;
generating, by the first IoT device, a communication containing the encrypted device protection code in a body of the communication;
transmitting the communication to a recipient device;
extracting, by the recipient device, the encrypted device protection code from the communication;
providing, by the recipient device, the encrypted device protection code to the DASP engine with an identifier of the first IoT device;
authenticating, by the DASP engine, the first IoT device using the encrypted device protection code;
providing, by the DASP engine, an authentication result to the recipient device; and
processing, by the recipient device, the communication if the authentication result authenticates the first IoT device and preventing processing of the communication if the authentication result does not authenticate the first IoT device.
